(19) United States
(12) Patent Application Publication
(10) Pub. No.: US 2011/0053496 A1
(43) Pub. Date: Mar. 3, 2011

(54) METHOD OF DETERMINING TRANSMISSION TIMING IN RELAY STATION

(76) Inventors: Junhong Hui, Daejeon-city (KR); Young-il Kim, Daejeon-City (KR); Soonyong Song, Daejeon-city (KR)

(21) Appl. No.: 12/812,768

(22) PCT Filed: Jan. 15, 2009
(86) PCT No.: PCT/KR2009/000199

§ 371 Date: Jul. 14, 2010

(30) Foreign Application Priority Data
Jan. 15, 2008 (KR) 10-2008-0004591
Jan. 24, 2008 (KR) 10-2008-0007619
Jan. 24, 2008 (KR) 10-2008-0007717
Jan. 14, 2009 (KR) 10-2009-0003013

(51) Int. Cl. H04B 17/02

(52) U.S. Cl. 455/9

(57) ABSTRACT

A method of determining transmission timing in a relay station is provided. The relay station in a mobile communication system formed of the relay station and a base station generates a processing capability reporting message including information about the processing capabilities in a down link and an up link of the relay station and transmits the processing capability reporting message to the base station.

### TECHNICAL FIELD

The present invention relates to a multi-hop relay system having a timing budget at a physical layer (PHY) and a media access control (MAC) layer in order to improve transmission capacity and data transmission rate of a wireless system, and more particularly, to transmission timing in a relay station (RS) which may be realized in a mobile multi-hop relay (MMR) system and allows the efficient use of bandwidth.

### BACKGROUND ART

A mobile multi-hop relay (MMR) system includes a base station (BS), a mobile station (MS), and at least one relay station (RS). A link between a BS and an RS denotes a relay link and a link between an RS and an MS denotes an access link. An MMR system is classified into a transparent mode and a non-transparent mode. In the transparent mode, a frame is divided into a down link (DL) and an up link (UL) and the DL is divided again into an area where the BS directly communicates with the MS or the RS, that is, a direct relay zone, and a transparent zone for relaying data to the MS through the RS. The UL is divided into an access zone for the MS to communicate with the RS or the BS and a relay zone for the RS to communicate with the BS.

In the non-transparent mode, a frame is divided into the UL and the DL. Each link is divided into an access zone for the MS to directly communicate with the RS or the BS and a relay zone for providing a link between the BS and the RS. In other words, the transparent zone, as in the transparent mode, does not exist in the non-transparent mode.

The start time for relay UL allocation denotes an effective start time of the UL defined in an R-MAP on a relay link (R-link). Here, the R-MAP defines UL and DL intervals on the R-link for Orthogonal Frequency Division Multiplexing (OFDM)-physical layer (PHY).

When the effective start time is defined as 0, the UL allocation defined in the R-MAP is effective in a current frame. When the value of the effective start time is N, the UL allocation defined in the R-MAP of an i^{th} frame is effective in an i+N^{th} frame.

In the non-transparent mode, UL relay allocation start time targeting transmission timing in the UL relay link after receiving data from a UL access link with respect to an RS is transmitted to one or all RS from the BS.

However, there is a problem regarding other link connection conditions, like the UL relay allocation start time for transmission timing in the UL relay link after receiving data from the UL relay link for non-transparent RS in a 2-hop or more MMR system. The DL relay allocation start time including transmission timing in the DL relay link after receiving data from the DL relay link with respect to the non-transparent RS in the 2-hop or more MMR system or the DL relay allocation start time including transmission timing in the DL access link after receiving data from the DL relay link in a transparent RS/non-transparent auxiliary system operate in a similar manner.

### DETAILED DESCRIPTION OF THE INVENTION

### Technical Problem

The present invention provides a method of determining transmission timing in a relay station (RS) which may be realized in a mobile multi-hop relay (MMR) system and allows the efficient use of bandwidth.

### Technical Solution

According to an aspect of the present invention, there is provided a method of reporting processing capabilities of a relay station in a mobile communication system formed of the relay station and a base station, the method including: generating a processing capability reporting message including information about the processing capabilities in a down link and an up link of the relay station; and transmitting the processing capability reporting message.

### ADVANTAGEOUS EFFECTS

According to the present invention, a relay station (RS) may determine transmission timing for transmitting frames by using bandwidth efficiently.

### DESCRIPTION OF THE DRAWINGS

FIG. 1 is a table showing Type Length Value (TLV) for reporting processing capabilities of a relay station (RS) according to an embodiment of the present invention;

FIG. 2 is a table showing processing capability TLV for reporting processing capabilities of an RS according to another embodiment of the present invention;

FIG. 3 is a table showing processing capability TLV for reporting processing capabilities of an RS according to another embodiment of the present invention;

FIG. 4 is a table showing an R-link Channel Descriptor (RCD) TLV for calculating a timing budget according to an embodiment of the present invention;

FIG. 5 is a table showing an R-link specific information element (IE) according to an embodiment of the present invention; and

FIG. 6 is a flowchart illustrating a method of reporting the processing capabilities of an RS according to an embodiment of the present invention.

### MODE FOR INVENTION

Timing information for both down link (DL) and up link (UL) needs to be transmitted to a relay station (RS) from a base station (BS), in consideration of the to following circumstances.

1. In a transparent RS system, it is required that the BS informs the RS of the time for transmitting data received in an access zone of a current frame, in order to match DL-MAP allocation, which may be directly received by a mobile station (MS). Here, the DL-MAP is a map defining a DL interval in an access link.

For example, when a direct relay zone is used, the received data is transmitted in the same frame. On the other hand, since there is possibility for the RS not to complete all processes including decoding, demodulation, upper layer processing, encoding, and modulation within one frame, the RS may be informed about a delay of the allocation start time for RS access link transmission. The timing value for such a relay transmission start time may depend on not only a decoding delay but also on other processing times such as upper layer control information.

2. In a non-transparent RS system, when the system has a large frame of 20 ms, a plurality of relay zones may exist in one frame. In order to reduce a delay, the BS may require the RS to receive data in a previous relay zone and to transmit data in a rear relay zone within the same frame.

3. In consideration of a multi-hop system, adaptive modulation and an encoding method may be used and may cause large and frequent changes in timing information in the relay link. The RS or the BS may be required to transmit the timing information to a receiving RS by using an appropriate method using an R-link specific information element (IE). Here, the R-link specific IE is an IE for the RS in a non-transparent mode and has a format including type, length, and specific data.

When it is not required to frequently change the timing information, a field for a generic channel description of R-link Channel Descriptor (RCD)-Type Length Value (TLV) encoding may be adopted, instead of the R-link specific IE.

4. In distributed scheduling in a 2-hop or more system, in order to use bandwidth more efficiently, the timing information for both access zone and relay zone may be clarified with a symbol unit and a receiving RS may be informed about the symbol unit so as to form the access zone and the relay zone of the RS itself according to a change in traffic rate between the access zone and the relay zone.

In a mobile multi-hop relay (MMR) system, timing budget information of the RS with respect to each link includes four types.

1) a relay UL link transmission timing budget (timing delay) after receiving data from the UL relay link

2) a relay UL link transmission timing budget (timing delay) after receiving data from the UL access link

3) a relay DL link transmission timing budget (timing delay) for data transmitted to the access link

4) a relay DL link transmission timing budget (timing delay) for data transmitted to the relay link

Since such information is definitely needed in terms of implementing the MMR system, the timing information needs to be exchanged during a network entry procedure or an SBC capability negotiation procedure, in consideration of RS is demodulation and an upper layer processing delay in the various links mentioned above. Here, SBC denotes Subscriber Stations (SS) Basic Capability.

The RS reports timing processing capabilities in all links to the BS through a processing capability reporting message. Here, an SS basic capability request (SBC-REQ) message defined in IEEE 802.16j may be used as the processing capability reporting message. Then, the BS determines a timing delay value for all links with reference to the processing capability information of the RS received through the processing capability reporting message along with other essential elements such as a frame structure and informs the RS of the timing delay value determined through a processing capability response message. Here, an SS and RS basic capability response (SBC-RSP) message defined in IEEE 802.16j may be used as the processing capability response message. Such timing reference information is used by the RS to to set the timing budget for each link.

For example, in a centralized scheduling RS system, the RS determines a relay frame delay of the received data and message by using the timing reference information received from the BS. When the value for transmitting data to the DL access link represents 2 frames, the RS relays data received in the i^{th} frame in the i+2^{th} frame.

As another example of a distributed relay system, the RS may determine transmission delay values of the received data and message by using the timing reference information received from the BS. The RS considers the timing reference information during scheduling.

In a simple case, the RS may report only DL and UL processing capabilities by using the processing capability reporting message.

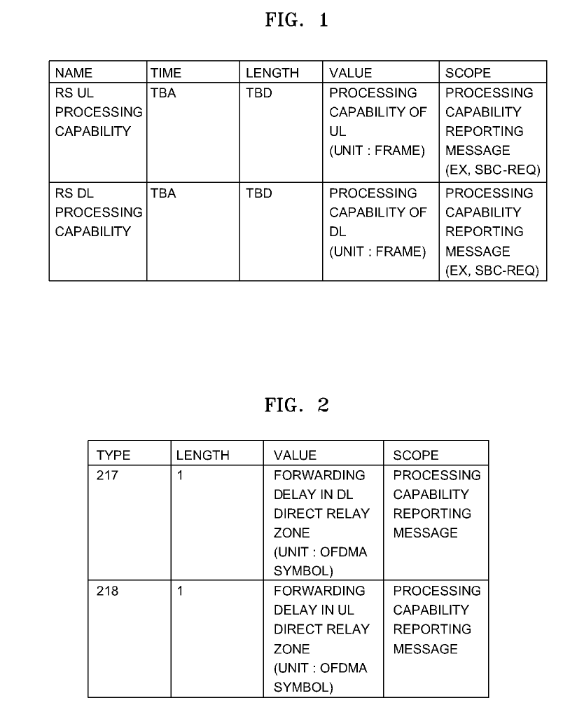

FIG. 1 is a table showing processing capability TLV for reporting the processing capabilities of the RS according to an embodiment of the present invention.

Referring to FIG. 1, the TLV denotes the processing capabilities of the RS for both DL and UL. The processing capabilities may be represented by frame units. During a network entry procedure or a SBC capability negotiation procedure, the RS reports RS processing capabilities in both DL and UL to the BS by using the processing capability reporting message (for example, a SBC-REQ message).

FIG. 2 is a table showing processing capability TLV for reporting processing capabilities of the RS according to another embodiment of the present invention.

Referring to FIG. 2, the TLV denotes a delay in receiving and forwarding data in a centralized scheduling mode by the RS in the direct relay zone. That is, the TLV denotes information about RS forwarding delay in the DL direct relay zone and RS forwarding delay in the UL direct relay zone. The forwarding delay value may be represented by an Orthogonal Frequency Division Multiple Access (OFDMA) symbol unit. The TLV may be reported to the BS through the processing capability reporting message (for example, a SBC-REQ message).

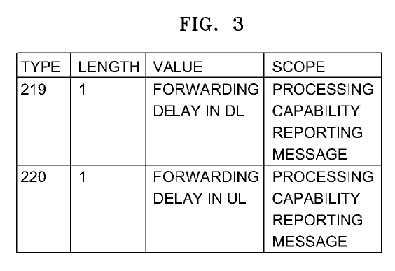

FIG. 3 is a table showing processing capability TLV for reporting processing capabilities of the RS according to another embodiment of the present invention.

Referring to FIG. 3, the TLV denotes a minimum delay in receiving and forwarding a media access control packet data unit (MAC PDU) by the RS in a centralized scheduling mode. More specifically, TLV denotes information about RS forwarding delays in both DL and UL. The TLV may be reported to the BS through the processing capability reporting message (for example, a SBC-REQ message).

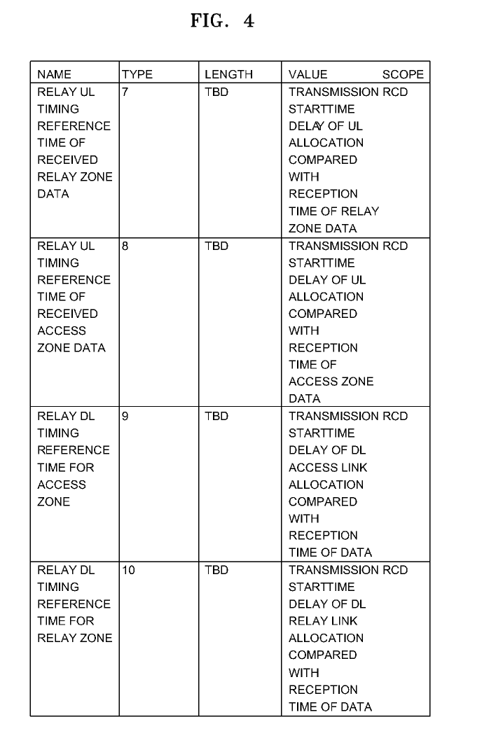

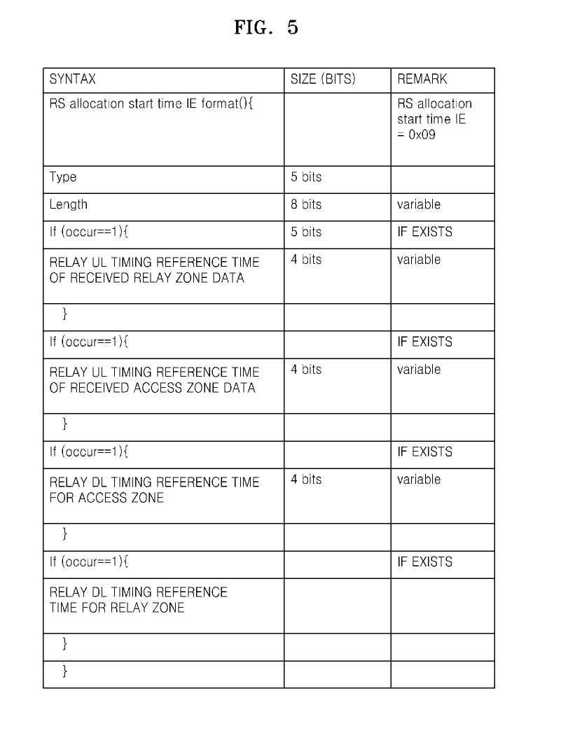

When a timing value is needed as a variable according to embodiments, RCD TLV in FIG. 4 or R-Link specific IE in FIG. 5 are used to calculate the timing budget.

FIG. 4 is a table showing an RCD TLV for calculating the timing budget according to an embodiment of the present invention.

Referring to FIG. 4, the relay UL timing reference time of the received relay zone data denotes the transmission start time delay value of the data, compared with the reception time of the received relay zone data. When the value represents 1 frame, UL allocation of the received relay zone data starts from the next frame.

The relay UL timing reference time of the received access zone data denotes the transmission start time delay value of UL allocation of the data, compared with the reception time of the access zone data. When the value represents 1 frame, UL allocation of the received access zone data starts from the next frame.

The relay DL timing reference time for the access zone denotes the transmission start time delay value of DL allocation of the data, compared with the reception time of the received access zone data. When the value represents 1 frame, DL allocation of the received access zone data starts from the next frame.

The relay DL timing reference time for the relay zone denotes the transmission start time delay value of DL allocation of the data, compared with the reception time of the relay zone data. When the value represents 1 frame, DL allocation of the received relay zone data starts from the next frame.

FIG. 5 is a table showing an R-link specific IE according to an embodiment of the present invention.

When it is not required to frequently change the timing information, a field for a generic channel description of an RCD-TLV may be replaced with an R-link specific IE.

Referring to FIG. 5, the RS allocation start time IE denotes timing of both DL and UP relay transmission start time of the operational RS in the transmitted R-link specific IE.

The relay UL timing reference time of the received relay zone data denotes the transmission start time delay value of UL allocation of the data, compared with the is reception time of the received relay zone data. When the value represents 1 frame, UL allocation of the received relay zone data starts from the next frame.

The relay UL timing reference time of the received access zone data denotes the transmission start time delay value of UL allocation of the data, compared with the reception time of the access zone data. When the value represents 1 frame, UL allocation of the received access zone data starts from the next frame.

The relay DL timing reference time for the access zone denotes the transmission start time delay value of DL allocation of the data, compared with the reception time of the received access zone data. When the value represents 1 frame, DL allocation of the received access zone data starts from the next frame.

The relay DL timing reference time for the relay zone denotes the transmission start time delay value of DL allocation of the data, compared with the reception time of the relay zone data. When the value represents 1 frame, DL allocation of the received relay zone data starts from the next frame.

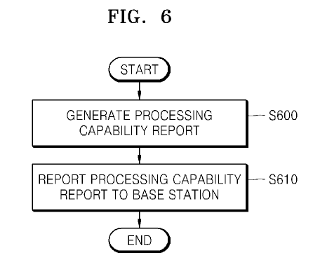

FIG. 6 is a flowchart illustrating a method of reporting processing capabilities of the RS according to an embodiment of the present invention.

Referring to FIG. 6, the RS generates the processing capability reporting message including information about its own processing capabilities, in operation 600. An SBC-REQ message defined in IEEE 802.16j may be used as the processing capability reporting message. The processing capabilities of the RS included in the processing capability reporting message may include the RS forwarding delay value in the direct relay zone (refer to the TLV of FIG. 2) or the RS forwarding delay values in both DL and UL (refer to the TLV of FIG. 3). Then, the RS transmits the generated processing capability reporting message to the BS, in operation 610. In this case, the RS may operate in a centralized scheduling mode.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of reporting processing capabilities of a relay station in a mobile communication system formed of the relay station and a base station, the method comprising:
generating a processing capability reporting message including information about the processing capabilities in a down link and an up link of the relay station; and
transmitting the processing capability reporting message.

2. The method of claim 1, wherein the generating of the processing capability reporting message comprises generating the processing capability reporting message including relay station forwarding delay information in the up link and relay station forwarding delay information in the down link as information about the processing capabilities.

3. The method of claim 1, wherein the generating of the processing capability reporting message comprises generating the processing capability reporting message including relay station forwarding delay information in a up link direct relay zone and relay station forwarding delay information in a down link direct relay zone as information about the processing capabilities.

4. The method of claim 1, wherein the relay station operates in a centralized scheduling mode.

5. A computer readable recording medium having embodied thereon a computer program for executing the method of reporting processing capabilities of a relay station in a mobile communication system formed of the relay station and a base station, the method comprising: generating a processing capability reporting message including information about the processing capabilities in a down link and an up link of the relay station; and transmitting the processing capability reporting message.

6. The computer readable recording medium of claim 5, wherein the generating of the processing capability reporting message comprises generating the processing capability reporting message including relay station forwarding delay information in the up link and relay station forwarding delay information in the down link as information about the processing capabilities.

7. The computer readable recording medium of claim 5, wherein the generating of the processing capability reporting message comprises generating the processing capability reporting message including relay station forwarding delay information in a up link direct relay zone and relay station forwarding delay information in a down link direct relay zone as information about the processing capabilities.

8. The computer readable recording medium of claim 5, wherein the relay station operates in a centralized scheduling mode.
